(19) United States
(12) Patent Application Publication
(10) Pub. No.: US 2015/0025978 A1
(43) Pub. Date: Jan. 22, 2015

(54) MARKETING ACKNOWLEDGEMENT SYSTEM FOR REAL-TIME EVENTS

(71) Applicant: ReapSo, LLC., Farmington Hills, MI (US)

(72) Inventors: William J. Wildern, IV, Farmington Hills, MI (US); Steven J. Valentine, Novi, MI (US)

(21) Appl. No.: 14/336,639

(22) Filed: Jul. 21, 2014

Related U.S. Application Data
(60) Provisional application No. 61/856,092, filed on Jul. 19, 2013.

(51) Int. Cl. G06Q 30/02

(52) U.S. Cl. CPC G06Q 30/0269
USPC 705/14.66

(57) ABSTRACT

Disclosed herein is a method for marketing for use with a real-time event that includes: receiving data indicative of demographic information from a plurality of users devices, each user account associated with at least one user; generating a promotional communication associated with the real-time event; receiving a plurality of responses to the promotional communication from at least some of the user devices; providing an offer to the user devices that have responded to the promotional communication; receiving a plurality of responses to the offer from at least some of the user devices; and transmitting, to a third party promoter or one or more content partners, data indicative of demographic information associated with users that have given at least a promotional communication response or an offer response.

### CROSS-REFERENCE TO RELATED APPLICATION

This application claims the benefit of U.S. Provisional Application No. 61/856,092, filed on Jul. 19, 2013, which is incorporated herein by reference in its entirety.

### BACKGROUND

The recent proliferation of internet-connected computing devices has led to the creation of many new channels by which content is delivered to customers. While many of these channels are sponsored by advertisements, consumers have become increasingly disengaged from advertising content as a result of constant exposure to advertising. As a result, many users ignore advertisements, or employ technological measures that prevent advertisements from being displayed in conjunction with the content that they are viewing. This has led to a decrease in the efficiency of advertising. At events that take place in real-time, individuals may be even more likely to disregard advertisements as their attention is focused on the main event.

### SUMMARY

Aspects of embodiments of methods, apparatuses and systems for marketing for use with a real-time event are disclosed herein.

In one aspect of the disclosed embodiments, a method includes receiving, at one or more server computers, data indicative of demographic information from a plurality of user devices. Each user account is associated with at least one user. The method includes generating, for display on at least some of the user devices, a promotional communication associated with the real-time event and receiving, at the one or more server computers, a plurality of responses to the promotional communication from at least some of the user devices. Further, the method includes providing an offer to the user devices that have responded to the promotional communication and receiving, at the one or more server computers, a plurality of responses to the offer from at least some of the user devices. The method also includes transmitting, to a remote third party server, data indicative of demographic information associated with users that have given at least a promotional communication response or an offer response.

In another aspect of the disclosed embodiments, a method includes providing, to one or more server computers, data indicative of demographic information of a user using a user device and receiving, on a user device, a promotional communication associated with the real-time event. The method also includes selectively transmitting, to the one or more server computers, a response to the promotional communication. If the user has responded to the promotional communication, the method includes receiving an offer on the user device. The method also includes selectively providing, to the one or more server computers, a response to the offer; and if the user has responded to the offer, receiving a reward for participating in the offer. Data indicative of the user's demographic information is transmitted by the one or more server computers to a remote third party server if the user has provided at least a promotional communication response or an offer response.

In another aspect of the disclosed embodiments, an apparatus includes a memory and a processor configured to execute instructions stored in the memory to receive data indicative of demographic information from a plurality of users devices, each user account associated with at least one user and generate, for display on at least some of the user devices, a promotional communication associated with the real-time event. The processor is also configured to execute instructions stored in the memory to receive a plurality of responses to the promotional communication from at least some of the user devices and provide an offer to the user devices that have responded to the promotional communication. Further, the processor is configured to execute instructions stored in the memory to receive a plurality of responses to the offer from at least some of the user devices and transmit, to a remote third party server, data indicative of demographic information associated with users that have given at least a promotional communication response or an offer response.

Other embodiments of the present invention will be apparent from the accompanying drawings and from the detailed description, which will be discussed in detail below.

### BRIEF DESCRIPTION OF THE DRAWINGS

The various features, advantages and other uses of the present apparatus will become more apparent by referring to the following detailed description and drawings in which:

FIG. 1 is an illustration showing an example of an implementation of a system for delivering demographic data to third parties;

FIG. 2 is an illustration showing an example of a user interface of the client application which displays promotional portals used in the system of FIG. 1;

FIG. 3 is an illustration showing an example of a user interface of the client application which displays a promotional communication used in the system of FIG. 1;

FIG. 4 is an illustration showing an example of a user interface of the client application as used in the system of FIG. 1, wherein the illustration displays the real-time feedback of the promotional communication and further displays an offer by a third party promoter or content partner;

FIG. 5 is an illustration showing an example of a user interface of the client application which displays an offer reward that the user receives for participating in the offer used in the system of FIG. 1;

FIG. 6 is a flowchart showing an example of a process used in the system of FIG. 1 to obtain and distribute demographic data;

FIG. 7 is a flowchart showing an example of a process used in the system of FIG. 1 for a user to obtain rewards for participation in a promotional communication; and

FIG. 8 is a block diagram of an example of a hardware configuration for the user device used in the system of FIG. 1.

### DETAILED DESCRIPTION

Targeting advertisements based on user demographics is one method to combat advertising inefficiency. This requires obtaining information regarding the user, which may be inaccurate or unavailable. In some instances, independent companies such as Nielsen (for television) and Arbitron (for radio), can supply demographic information based on certain estimates. For example, some companies supply the information by estimating audience composition based on sample sizes, which may be disproportionately small relative to the actual audience size. Because the information may be based on a small sample size, these techniques do not permit providing rich user demographic data. Accordingly, these techniques are not suitable for targeted advertising.

User demographic information can be obtained, in some instances, directly from users. However, many users may be reluctant to share demographic information. Embodiments of the invention described further herein provide for incentive-based methods to attract user participation during real-time events in order to measure customer engagement with the real-time event and in turn, obtain data necessary for targeted advertising. As will be discussed further below, a marketing acknowledgement system can, for example, provide a user with promotions and/or offers created by third party promoters and/or content partners. Users can provide demographic information and in turn participate in the promotions and/or offers in exchange for the ability to receive unique rewards.

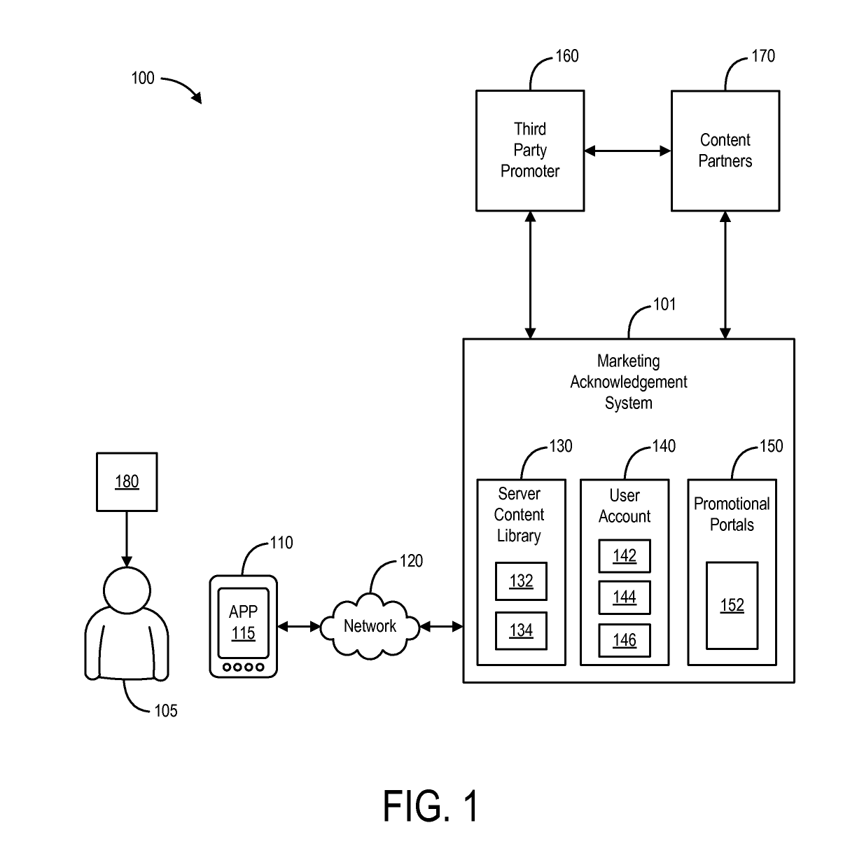

FIG. 1 is an illustration showing an example of an implementation of a system 100 for delivering demographic data to third parties. The system 100 includes a marketing acknowledgement system 101 as a mode of interaction between one or more user devices and third party promoters and content partners, each of which are described further herein.

A user device 110 is operable to communicate with the marketing acknowledgement system 101. The user device 110 can be a smart phone (computationally-enabled mobile telephone), tablet computer, laptop computer, desktop computer or other computing device that can connect to the server computers of the marketing acknowledgement system 101 via the network 120. The user device 110 can store and execute a client application 115. The client application 115 can be a software program that is stored in a storage medium that is associated with the user device 110 and includes computer program instructions that, when executed by the user device 110, cause the user device 110 to perform operations that will be described further herein.

The marketing acknowledgement system 101 can be implemented by, for example, one or more server computers. The marketing acknowledgement system 101 servers can be provided with software in the form of computer program instructions that, when executed by the servers, cause the one or more server computers to perform operations that will be described further herein.

The marketing acknowledgement system 101 uses a network 120, which can be, the Internet, a local area network (LAN), wide area network (WAN), campus area network (CAN), personal area network (PAN), storage area (SAN), or any network not listed herein that involves the transmission of signals and/or data between devices that are connected to the network 120. Communication between the user device 110 and marketing acknowledgement system 101, as well as other computer-based systems discussed herein, can occur via the network 120. Communication between the user device 110 and other components in the system 100 can occur using various other networks (e.g., cellular networks).

The marketing acknowledgement system 101 servers can interact with one or more third party promoters 160 and one or more content partners 170. A content partner 170 can be an individual or a business that communicates with the marketing acknowledgement system 101 or a third party promoter 160 by providing information relating to an advertising offer, which is described in detail further herein. A third party promoter 160 can be an individual or business that communicates with the marketing acknowledgement system 101 and may communicate with one or more content partners 170 by acting as the host of a promotional communication which is described in detail further herein.

Explanation of several different embodiments will demonstrate that, while the terms third party promoter 160 and content partner 170 can be used to represent different parties, embodiments exist wherein the parties themselves as well as their functions can overlap. In one embodiment, a third party promoter 160 can be the host of a promotional communication, and partner up with one or more content partners 170 who could provide an offer, both of which are described in detail further herein. In another embodiment, a third party promoter 160 may act as its own content partner 170. In this embodiment, the third party promoter 160 could perform the promotional communication as well as the advertising offer, both of which are described in detail further herein. In another embodiment, the one or more content partners 170 can act as a third party promoter 160. In this embodiment, the content partner 170 would perform the promotional communication as well as the advertising offer, both of which are described in detail further herein.

The marketing acknowledgement system 101 is comprised of a server content library, user account, and collection of promotional portals, each of which is described in detail below.

The server content library 130 can be used to store content items such as collectable items 132 and reward items 134 provided by, for example, the third party promoters 160 or the content partners 170. The collectible items 132 can include, but are not limited to, digital images, video, music, text and/or other information. The reward items 134 can include, but are not limited to coupons, contest or sweepstakes entries, or tokens that are issued by the either the third party promoters 160 or the content partners 170, and which can be redeemed for discounts, coupons, a chance to win a prize, goods and/or services.

A user device 110 may be used in order to create a user account 140, which holds information that is stored on the servers of the marketing acknowledgement system 101. A user account 140 can include a user content library 142, user preference information 144, and user demographic data 146. A user's demographic data 146 can identify information such as gender, age, ethnicity, race, place of residence and education. In some embodiments, the user demographic data 146 can be transmitted to the third party promoters 160 or content partners 170. Both the third party promoters 160 and content partners 170 can, in one embodiment, receive the transmission on their own respective servers (e.i., a remote third party server). Each user account 140 can include unique user preferences 144 that describe the likes and dislikes of the user 105. Additional information pertaining to user preferences 144 and their use for customized content delivery is described in detail in U.S. Publication No. 2013/0080218, which was filed on Sep. 20, 2012, assigned to the same assignee as this invention, and is incorporated by reference herein in its entirety. Each user account 140 can also include a user content library 142. The user content library 142 allows content items to be associated with the user account 140. For example, the user content library 142 can be defined by information identifying the content items from the server content library 130 that the user associated with the user account 140 is permitted to access. In some implementations, the user can view representations of the items in the user content library 142 in the form of a user interface of the client application 115. Items in the user content library 142 may, but need not be, transferred to and stored at a storage medium that is associated with the user device 110.

The marketing acknowledgement system 101 can include a list of promotional portals 150 that represent different real-time events 180. A real-time event 180 may relate to, for example, a live event, show, concert, broadcast, individual, topic of interest or any combination thereof. A real-time event may not necessarily be one that is viewed by the user in real-time, but also includes events that are viewed at a later period. In one embodiment, the promotional portals 150 can be displayed on the client application 115 in such a way as to allow the user to select a specific portal 152 in order to view information or data unique to that portal 152. Each promotional portal 152 can be associated with a third party promoter 160 who acts in conjunction with or on behalf of a content partner 170, or a content partner 170 who acts as both the third party promoter 160 and the content partner 170, or in some instances, a third party promoter 160 who acts as its own content partner 170.

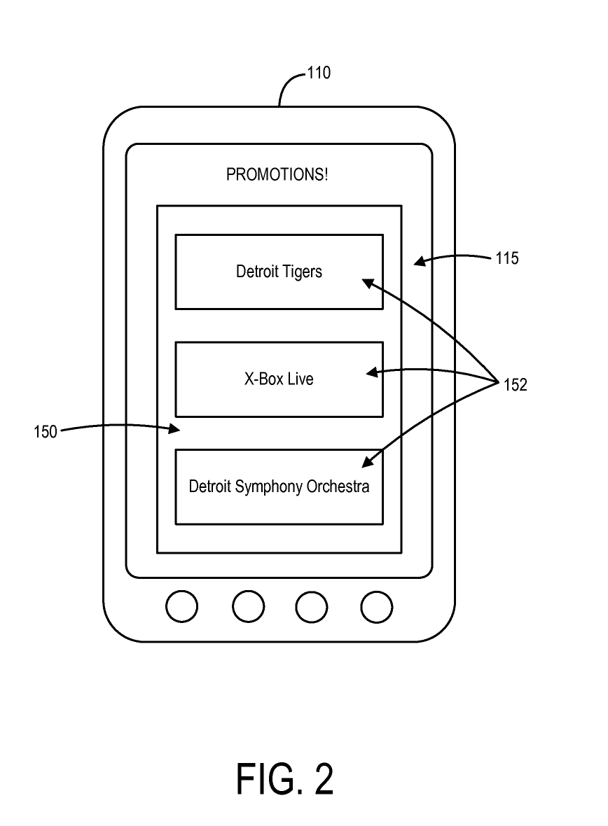

FIG. 2 is an illustration showing an example of a user interface of the client application, which displays promotional portals used in the system of FIG. 1. Each promotional portal can, for example, have a unique display on the user interface of the client application 115. The list of promotional portals 150 can include any number of or variety of real-time events. In the embodiment shown in FIG. 2, the list of promotional portals 150 includes a portal 152 for a Detroit Tigers baseball game, a portal 152 for an X-Box Live promotion, and a portal 152 for a Detroit Symphony Orchestra promotion. Access to the information within each promotional portal 152 can be obtained by a user selecting the desired portal 152. The user may select a promotional portal 152 via touchscreen, mouse, keyboard, voice activation, sensory-based acknowledgement or any other suitable technique. For example, access to information or data within each promotional portal 152 may be obtained by a user pressing on the touchscreen of the user interface for the client application 115. In another example, access to the promotional portal 152 information or data can be obtained by a user verbally communicating with the user device 110 by stating out loud the name of the promotional portal 152 that the user wishes to select. In another example, access to the promotional portal 152 information or data can be obtained by a user scanning or entering an access code into the user device 110.

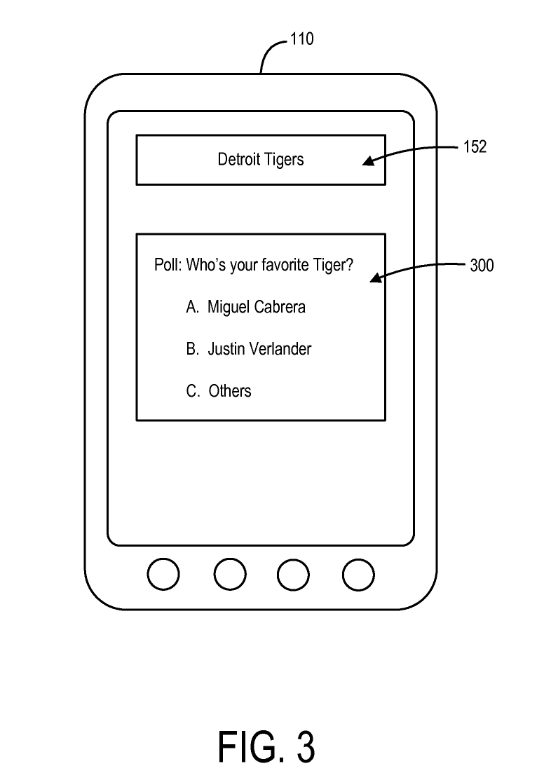

FIG. 3 is an illustration showing an example of a user interface of the client application, which displays a promotional communication used in the system of FIG. 1. Each promotional portal 152 may include any number of promotional communications 300. A promotional communication 300 can be at least one of a poll, a trivia, a survey, a questionnaire, an examination, an investigation, a study, a sample, or a canvass. The promotional communications listed herein are only examples of the types of promotional communications usable in embodiments of the invention. Other suitable promotional communications are available (e.g., a contest or a sweepstakes). The promotional communication 300 can be loaded to the marketing acknowledgement system 101 server via either a third party promoter 160 or one or more content partners 170.

In the example shown in FIG. 3, the promotional communication poses a question on the user interface of the client application 115 in order to ask the audience at a baseball game about their favorite player. In order to provide a response to the promotional communication 300, the user can select the desired option. In one embodiment, a user with a smart phone may select a response by pressing the portion of the touch screen that correlates to the desired answer. In other embodiments, the user may select a response through a variety of modes such as clicking with a mouse or keyboard, providing a voice command, sensor-to-eye recognition or any other suitable technique.

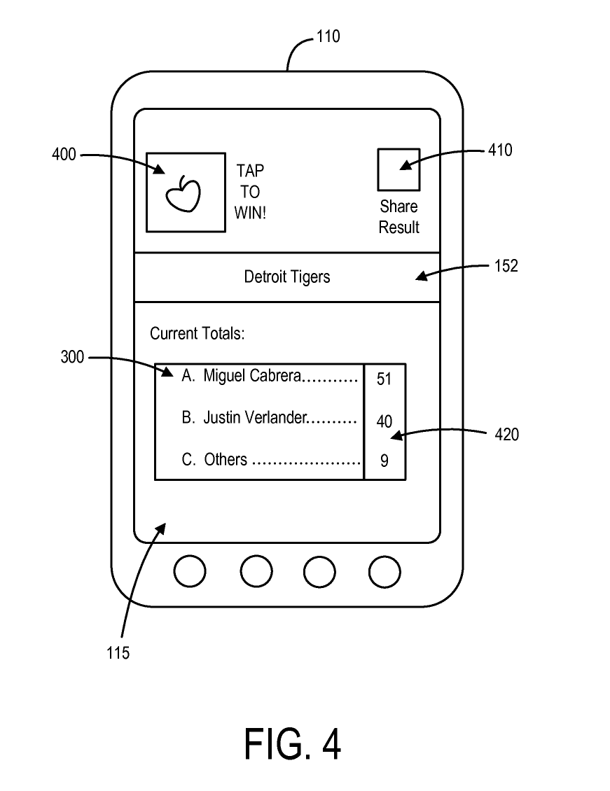

FIG. 4 is an illustration showing an example of a user interface of the client application 115 as used in the system of FIG. 1, wherein the illustration displays the real-time feedback 420 of the promotional communication 300. The real-time feedback 420 can be generated by the marketing acknowledgement system 101, which can compile data from each user 105 that transmits a response to the promotional communication 300. The real-time feedback 420 can be presented to the user, for example, to enhance user engagement and interest.

In one embodiment, the real-time feedback 420 can show a numerical representation of the number of votes for each respective category in the promotional communication 300. In other embodiments, the real-time feedback 420 can show any number of result-oriented solutions, for instance a numerical representation of the percentage of total votes for each respective category in the promotional communication 300. In the example shown in FIG. 4, the user interface of the client application 115 shows in real-time how many users have voted for Miguel Cabrera, how many users have voted for Justin Verlander, and how many users have voted for Other. In one embodiment, the user interface of the client application 115 can allow for the users who chose not to vote to view the real-time feedback 420. In another embodiment, users who do not vote cannot see the real-time feedback 420.

In some embodiments users can share the current status of the real-time feedback 420 with social media networks such as Facebook, Twitter, Instagram, Snapchat, Pinterest and Linked-In. The user 105 may share the real-time feedback 420 by selecting the Share Result button 410 displayed on the user interface of the client application 115. In other embodiments, the user may share the results through a variety of modes such as clicking with a mouse or keyboard, providing a voice command, sensor-to-eye recognition or any other suitable technique. In another embodiment, the user 105 may also share the real-time feedback with another user via, for example, email or an instant messaging service.

The user interface screen of FIG. 4 further displays an offer 400. The offer 400 can be an opportunity for a user to win something from the third party promoter 160 or content partner 170. In some embodiments, the offer provides the user 105 with an opportunity to win something by permitting the user to click on a button, which can act as an advertisement, solicitation, or deal. The offer 400 can include any number of rewards, which are discussed further herein.

In one embodiment, users who participate in the promotional communication 300 can participate in the offer 400 by selecting a button on their smart phone. For example, as shown in FIG. 4, a smart phone user may select the offer by pressing the portion of the touch screen on the client application 115, which contains a digital image of a peach. In other embodiments, the user may select the offer through a variety of modes such as clicking with a mouse or keyboard, providing a voice command, sensor-to-eye recognition or any other suitable technique. The digital image used to represent the offer 400 can be shown via a multitude of different objects, such as those relating to the client application 115, the third party promoter 160, the content partner 170, the user's personal references 144, or any other suitable image, sound, object, or text.

The offer 400 also can include a limited accessibility feature, wherein a user who selects the offer 400 but has not participated in the promotional communication 300 may be denied access and reminded to participate in the promotional communication 300 in order to obtain eligibility for the offer's rewards 500. In another embodiment, a user who selects the offer 400 but has not participated in the promotional communication 300 may be unable to select or click on the offer 400.

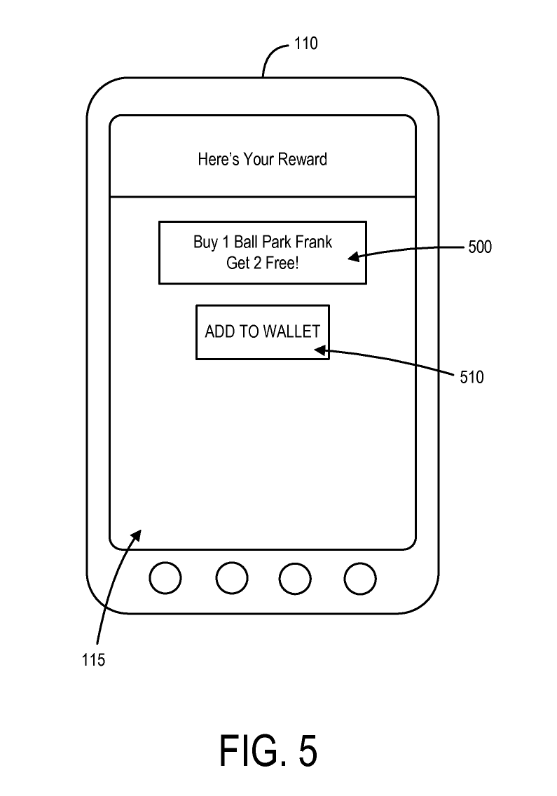

FIG. 5 is an illustration showing an example of a user interface of the client application 115, which displays an offer reward 500 that the user receives for participating in the offer 400 used in the system of FIG. 1. An offer reward 500 is provided by either a third party promoter 160 or a content partner 170. An offer reward 500 can include a coupon, gift certificate, cash advance, contest entry, sweepstakes entry, or any other suitable form of reward.

While the example shown in FIG. 5 shows a singular offer reward 500, alternative embodiments allow for the offer reward 500 to be comprised of a list of rewards in order to give the user a choice as to which incentive to select. The user may, depending on the restrictions of the promotion and the reward system, select multiple rewards from a list of rewards.

FIG. 5 provides for an “ADD TO WALLET” button 510 on the client application 115, which allows the user to store the offer rewards 500 that the user has obtained. Once the user selects the “ADD TO WALLET” button 510, the reward is stored on the user content library 142 for future use. In one embodiment, the storage space can be referred to as a “virtual wallet.” In the example shown in FIG. 5, a user could store the “Buy 1 Ballpark Frank, Get 2 Free” coupon into the virtual wallet for use at a future baseball game. In another example, a user could select multiple offer rewards 500 and store each offer reward 500 using the “ADD TO WALLET” button 510. For instance, as shown in FIG. 5, a user could press the image or text of the user interface on the client application 115, which displays “ADD TO WALLET.” In other embodiments, the “ADD TO WALLET” button 510 could include any number of different textual or pictorial descriptions.

If the reward must be redeemed, the user may spend the offer reward 500 in person by immediately presenting the display image of the coupon to the business to which the coupon applies. In other embodiments, reward redemption can be achieved via email, via an access code unique to the user account 140, via calling or texting the third party promoter 160 or content partner 170, or through any other suitable technique.

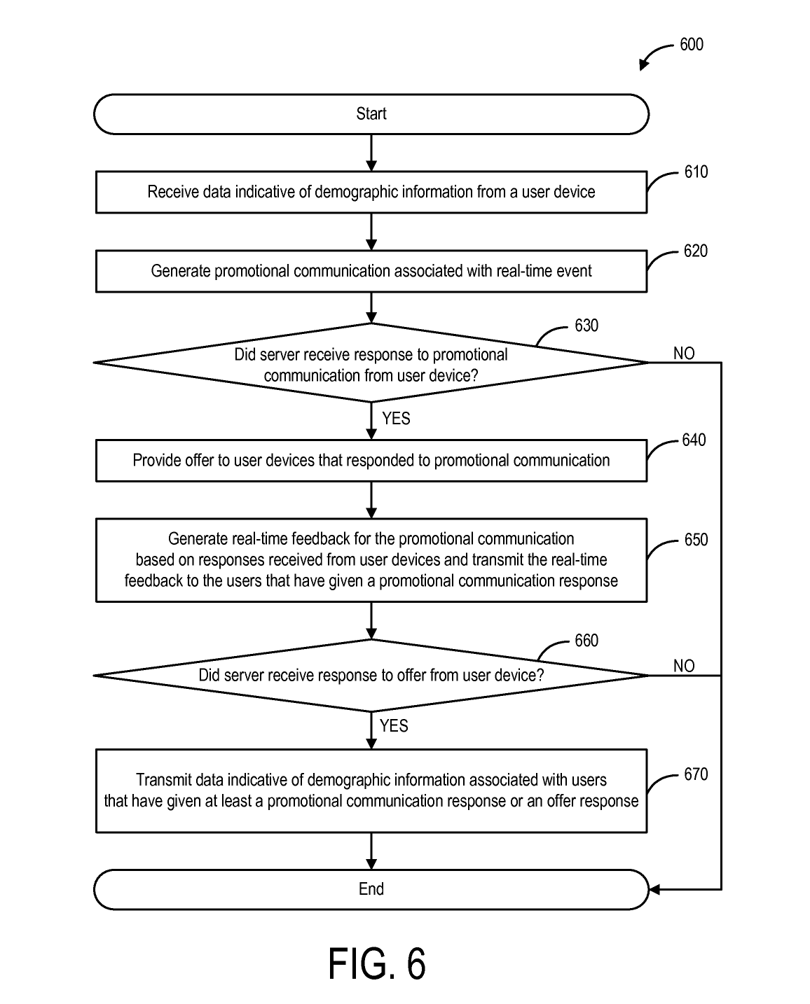

FIG. 6 is a flowchart showing an example of a process used in the system 100 of FIG. 1 to obtain and distribute demographic data.

At operation 610, data indicative of demographic information is received from one or more user devices 110. Demographic information can be comprised of gender, age, ethnicity, race, place of residence, contact information, education and any other data that could be considered demographic. The demographic data, once received, can be stored in the user account 140 of the marketing acknowledgement system 101.

At operation 620, a promotional communication 300 associated with a real-time event is generated. The promotional communication 300 that is generated can be comprised of a poll, a trivia, a survey, a questionnaire, an examination, an investigation, a study, a sample or a canvass. In the example given in FIG. 3, the promotional communication 300 presents a one-question survey designed to ask the fans at a baseball stadium who their favorite player is on the Detroit Tigers. In some embodiments, the user may only have limited time period to access and be able to respond to the promotional communication 300. For instance, in the example from FIG. 3, the user may only be able to respond by the end of the 8th inning if the third party promoter 160 means to display the final results during the 9th inning.

At operation 630, the server of the marketing acknowledgement system 101 checks to determine which of the users responded to the promotional communication 300. The server stores the response data on the server each time a user responds to the promotional communication 300. The server can verify each user response by receiving at least one of a scanned validation code, an audio message, or a text message from the corresponding user device. In one embodiment, the server can consider whether a predetermined temporal deadline (e.g., 15 minutes) has passed as an additional mode of verification.

At operation 640, the offer 400 discussed in connection with FIG. 4 above, is provided to each of the user devices 110 that have responded to the promotional communication 300. In one embodiment, the offer 400 can include the image of an object displayed as a button on the user interface of the client application 115 which the user can select in order to be eligible to receive a reward 134. In related embodiments, the offer 400 could include a different display on the user interface of the client application 115, such as an actual advertisement or promotional display. For instance, a content partner 170 could partner with a third party promoter 160 who is hosting a live event and make the offer 400 display a unique item that the content partner 170 is trying to promote or solicit.

At operation 650, the marketing acknowledgement system 101 generates and transmits real-time feedback 420 to the user devices 110. The real-time feedback 420 is based upon responses received from the user devices 110. The marketing acknowledgement system 101 server can compile user responses to calculate real-time totals. The real-time totals can be displayed on the results page of the promotional portal 152 so that each user to update the client application 115 has access to real-time feedback 420.

At operation 660, the marketing acknowledgement system 101 checks for responses to the offer 400 from each user device 110. Each time a user selects the offer 400, a response message can be sent from the user device 110 to the marketing acknowledgement system 101.

At operation 670, the marketing acknowledgement system 101 transmits data indicative of demographic information associated with users that have given at least a promotional communication response or an offer response to, for example, the third party promoter 160 or content partner 170 associated with the real-time event. In one embodiment, the third party promoter 160, acting as its own sponsor and providing its own offer 400, receives demographic data from user accounts 140 that participate directly in the offer 400.

In another embodiment, the third party promoter 160 does not sponsor its own real-time event, and as a result, uses one or more content partners 170 to provide the offer 400. In this embodiment, the one or more content partners 170 can receive demographic data from user accounts 140 that participate directly in the offer 400. The content partners can be, for example, businesses that contract directly with the host of the marketing acknowledgement system 101 server. For example, an announcer at a baseball game could act as the third party promoter 160, and a plurality of fast food chains could act as content partners 170. The users may have user preferences 140 saved to their user accounts 140 such as a fast food preference. When users at the baseball game click on the promotional communication 300, and then subsequently click on the offer 400, the offer reward 500 that is available to each user could be unique to each user account 140 depending on the user preferences. Each offer reward 500 received by a user can be used immediately or stored in the user's content library 142. For instance, if Company A is a content partner, a user who selected Company A as their favorite fast food chain may receive a Company A promotional reward in exchange for Company A receiving their demographic information. A second user in the same embodiment may have Company B selected as their favorite fast food chain, which may allow the second user to receive a Company B promotional reward in exchange for their demographic information. In this embodiment, the offer 400 button that each use selects could be specific to each content partner 170. In other embodiments, such as that shown in FIG. 4, the offer 400 could be a generic icon such as the logo of the host of the marketing acknowledgement system 101.

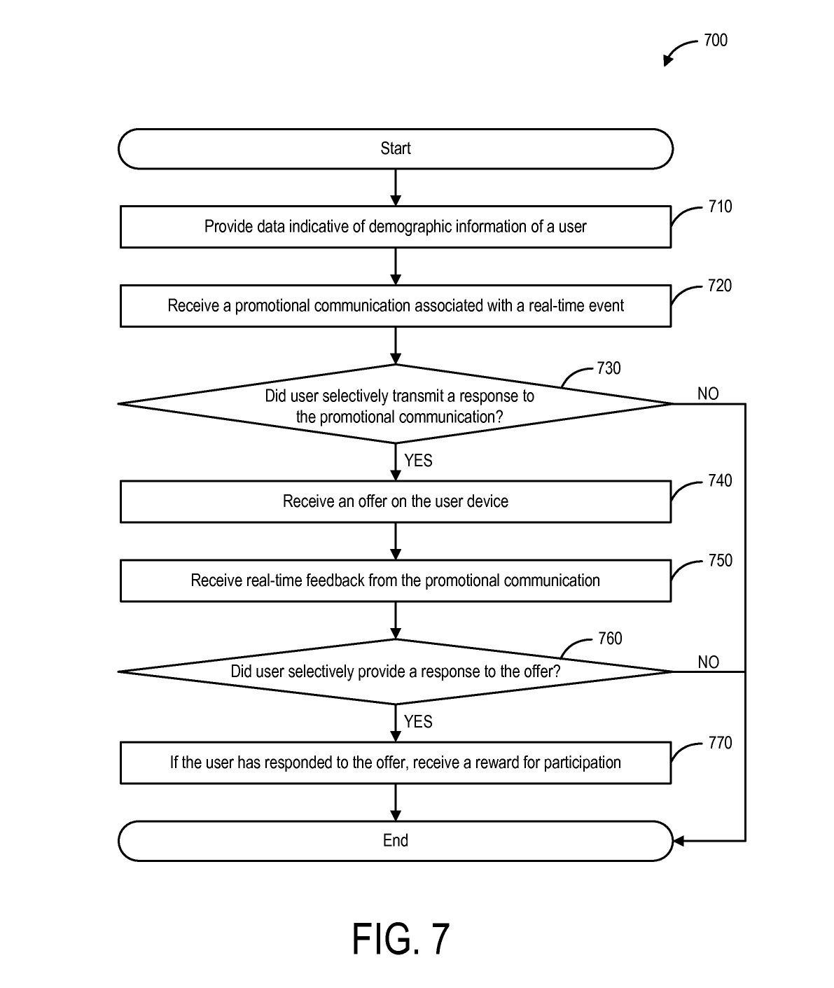

FIG. 7 is a flowchart showing an example of a process used in the system of FIG. 1 for a user to obtain rewards for participation in a promotional communication.

At operation 710, the user 105 provides data indicative of demographic information. The user can submit the demographic data from a user device 110. A user's demographic data 146 is stored in the user's account 140. It is not necessary to re-enter demographic information at the beginning of each operation 710.

At operation 720, a user device receives a promotional communication 300 associated with a real-time event. In the example given in FIG. 3, the user is able to view the promotional communication 300 on the user device 110.

At operation 730, each user can selectively transmit a promotional communication 300 response to the marking acknowledgement system 101 server. The user 105 may transmit a response using a user device 110 during a predetermined time period where the promotional communication 300 is active. If the user 105 submits a response, control moves to operation 740. Otherwise, the process ends.

At operation 740, each user that responds to the promotional communication 300 receives an offer 400. The user can view the offer 400 on the user device 110 or through alternative modes such as email. In one embodiment, the offer 400 can be accepted by clicking on a button on the user interface of the client application 115 which can show a multitude of different objects or advertisements. In one example, the offer 400 button can show the logo of the owner of the marketing acknowledgement system 101. In another example, the offer 400 button can show an advertisement or object specific to the third party promoter 160 or content partner 170.

At operation 750, real-time feedback 420 from the promotional communication 300 is received on the user's device 110 as discussed above. The real-time feedback 420 can occur through an update on the user interface of the client application 115 or through alternative modes such as email. In one example, a user who is first to respond to the promotional communication 300 would be brought to a results page on the user interface of the client application 115 which would show that the user was the only person to respond. For instance, if the question was “Who is Your Favorite Detroit Tiger?”, and the user responded “Miguel Cabrera”, the real-time feedback 420 display on the user interface of the client application 115 would show that one user responded “Miguel Cabrera” and zero users responded “Justin Verlander” or “Other.” If a second user subsequently responded to the promotional communication 300 by selecting “Justin Verlander”, the second user would be brought to a display on the user interface of the client application 115 that showed that one individual responded “Miguel Cabrera”, one individual responded “Justin Verlander”, and zero individuals responded “Other.”

At operation 760, each user 105 may selectively transmit an offer 400 response. In one embodiment, a user may respond to the offer 400 by selecting the offer 400 button on the user interface of the client application 115. In other embodiments, alternative modes of responding to the offer 400 may be provided. For instance, the user may selectively respond to the offer 400 via email.

At operation 770, each user that responds to the offer 400 receives an offer reward 500 for participation. In one embodiment, the offer reward 500 can be stored on the user content library 142 using a virtual wallet. The reward can be stored, for example, by selecting the “ADD TO WALLET” button 510 on the user interface of the client application 115. In another embodiment, the offer reward 500 can be spent at the real-time event through any number of reasonable modes of delivery. For instance, the user could show a real-time event employee the reward icon on the user's smart phone. In another embodiment, the offer reward 500 could be a contest or sweepstakes entry that is redeemed immediately by the user for a chance to win something. In another embodiment, the offer reward 500 could be sent to the user via email or any other reasonable mode of delivery.

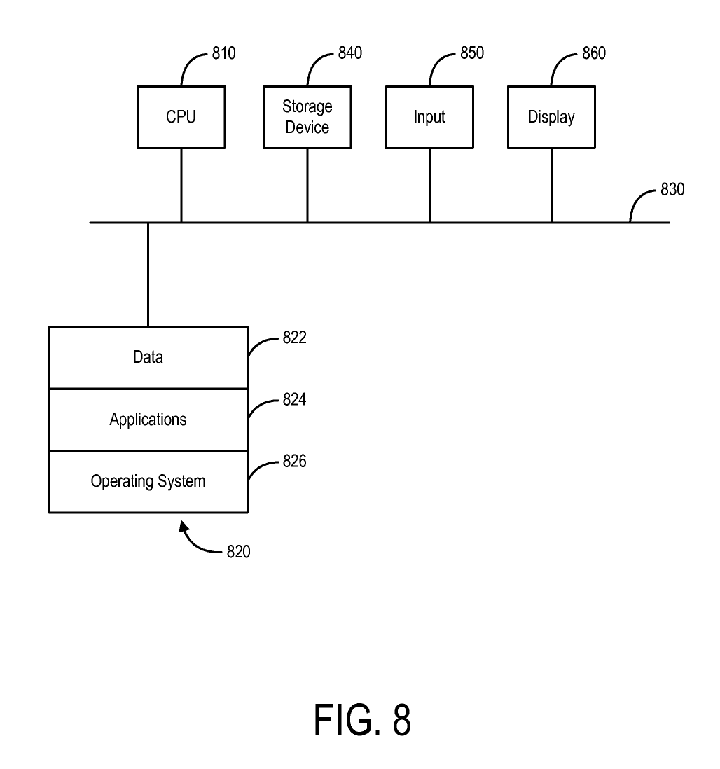

FIG. 8 is a block diagram of an example of a hardware configuration for the user device used in the system of FIG. 1. Other computers, systems, and/or devices described herein can be implemented using a similar configuration.

The CPU 810 of the user device 110 can be a conventional central processing unit. Alternatively, the CPU can be any other type of device, or multiple devices, capable of manipulating or processing information now-existing or hereafter developed. Although the disclosed examples can be practiced with a single processor as shown, e.g. CPU 810, advantages in speed and efficiency can be achieved using more than one processor.

The user device 110 can include memory, such as a random access memory device (RAM). Any other suitable type of storage device can be used as the memory. The memory can include code and data 822, one or more application programs 824, and an operating system 826, all of which can be accessed by the CPU 810 using a bus 830. The application programs 824 can include programs that permit the CPU 810 to perform the methods described herein.

A storage device 840 can be optionally provided in the form of any suitable computer readable medium, such as a hard disc drive, a memory device, a flash drive or an optical drive. One or more input devices 850, such as a keyboard, a mouse, a scanner, a voice sensitive input device, or a gesture sensitive input device, receive user inputs and can output signals or data indicative of the user inputs to the CPU 810. One or more output devices can be provided, such as a display device 860. The display device 860, such as a liquid crystal display (LCD) or a cathode-ray tube (CRT), allows output to be presented to a user, for example, in response to receiving a video signal.

Although the CPU 810 and the memory 1020 of the user device 110 are depicted as being integrated into a single unit, other configurations can be utilized. The operations of the CPU 810 can be distributed across multiple machines (each machine having one or more of processors), which can be coupled directly or across a local area or other network. The memory can be distributed across multiple machines such as network-based memory or memory in multiple machines performing the operations of the user device 110. Although depicted here as a single bus, the bus 830 of the user device 110 can be composed of multiple buses. Further, the storage device 840 can be directly coupled to the other components of the user device 110 or can be accessed via a network and can comprise a single integrated unit such as a memory card or multiple units such as multiple memory cards. The user device 110 can thus be implemented in a wide variety of configurations.

The computers and/or devices described herein (and the algorithms, methods, instructions etc. stored thereon and/or executed thereby) can be realized in hardware including, for example, intellectual property (IP) cores, application-specific integrated circuits (ASICs), programmable logic arrays, optical processors, programmable logic controllers, microcode, firmware, microcontrollers, servers, microprocessors, digital signal processors or any other suitable circuit. In the claims, the term “processor” should be understood as encompassing any of the foregoing, either singly or in combination. The terms “signal” and “data” are used interchangeably.

In some implementations, operations described herein as being performed by a single computer or device can be performed by multiple computers and/or devices. In other implementations, the operations described herein as being performed by multiple computers and/or devices can be performed by a single computer or device. Although illustrated for simplicity as unitary machines, it is understood that the computers and devices shown and described herein are not necessarily implemented using a single processor, or a single physical machine. Moreover, although features may be described above or claimed as acting in certain combinations, one or more features of a combination can in some cases be excised from the combination, and the combination may be directed to a sub-combination or variation of a sub-combination.

In another example, the computers and/or devices described herein can be implemented using general purpose computers/processors with a computer program that, when executed, carries out any of the respective methods, algorithms and/or instructions described herein. In addition or alternatively, for example, special purpose computers/processors can be utilized which can contain specialized hard-ware for carrying out any of the methods, algorithms, or instructions described herein.

Further, all or a portion of the embodiments of the disclosure can take the form of a computer program product accessible from, for example, a storage device or storage medium such as a non-transitory computer-usable or computer-readable medium. A storage device or storage medium can be any device that can, for example, tangibly contain, store, communicate, or transport the program for use by or in connection with any processor. The storage device or storage medium can be, for example, an electronic device, magnetic device, optical device, electromagnetic device, or a semiconductor device. Other suitable devices and mediums are also available.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for marketing for use with a real-time event, comprising:
receiving, at one or more server computers, data indicative of demographic information from a plurality of users devices, each user account associated with at least one user;
generating, for display on at least some of the user devices, a promotional communication associated with the real-time event;
receiving, at the one or more server computers, a plurality of responses to the promotional communication from at least some of the user devices;
providing an offer to the user devices that have responded to the promotional communication;
receiving, at the one or more server computers, a plurality of responses to the offer from at least some of the user devices; and
transmitting, to a remote third party server, data indicative of demographic information associated with users that have given at least a promotional communication response or an offer response.

2. The method of claim 1, wherein the demographic information is at least one of gender, age, ethnicity, race, place of residence and education.

3. The method of claim 1, wherein the promotional communication is at least one of a poll, a trivia, a survey, a questionnaire, an examination, an investigation, a study, a sample, or a canvass.

4. The method of claim 1, further comprising:
verifying, by the one or more server computers, each of the plurality of promotional communication responses by receiving at least one of a scanned validation code, an audio message, or a text message from the corresponding user device.

5. The method of claim 4, wherein verifying the promotional communication responses includes a determination as to whether each promotional communication response occurred prior to a predetermined temporal deadline.

6. The method of claim 1, wherein an offer is at least one of an advertisement, a solicitation, or a deal.

7. The method of claim 1, further comprising:
generating real-time feedback for the promotional communication based on responses received from the plurality of user devices and transmitting the real-time feedback to the plurality of user devices that have given a promotional communication response.

8. The method of claim 7, wherein at least one of the plurality of user devices shares the real-time feedback with a social media service.

9. The method of claim 1, further comprising:
transmitting, to the user devices that have provided either a promotional communication response or an offer response, one or more offer rewards.

10. The method of claim 9, wherein the one or more offer rewards can be stored in a virtual wallet in order to enable the user to access the one or more offer rewards at a future time.

11. A method for marketing for use with a real-time event, comprising:
providing, to one or more server computers, data indicative of demographic information of a user using a user device;
receiving, on a user device, a promotional communication associated with the real-time event;
selectively transmitting, to the one or more server computers, a response to the promotional communication;
if the user has responded to the promotional communication, receiving an offer on the user device;
selectively providing, to the one or more server computers, a response to the offer; and
if the user has responded to the offer, receiving a reward for participating in the offer;
wherein data indicative of the user's demographic information is transmitted by the one or more server computers to a remote third party server if the user has provided at least a promotional communication response or an offer response.

12. The method of claim 11, wherein demographic information is at least one of gender, age, ethnicity, race, place of residence, contact information and education.

13. The method of claim 11, wherein the promotional communication is at least one of a poll, a trivia, a survey, a questionnaire, an examination, an investigation, a study, a sample, or a canvass.

14. The method of claim 11, wherein each of the first responses from the plurality of user devices is verified by the one or more server computers receiving either a scanned validation code, audio message, or text message from each of the plurality of user devices.

15. The method of claim 11, wherein an offer includes an advertisement, solicitation, or deal.

16. The method of claim 11, further comprising:
receiving, real-time feedback pertaining to responses to the promotional communication received from other users.

17. An apparatus for marketing for use with a real-time event, comprising:
a memory; and
a processor configured to execute instructions stored in the memory to:
receive data indicative of demographic information from a plurality of users devices, each user account associated with at least one user;
generate, for display on at least some of the user devices, a promotional communication associated with the real-time event;
receive a plurality of responses to the promotional communication from at least some of the user devices;
provide an offer to the user devices that have responded to the promotional communication;
receive a plurality of responses to the offer from at least some of the user devices; and
transmit, to a remote third party server, data indicative of demographic information associated with users that have given at least a promotional communication response or an offer response.

18. The apparatus of claim 17, wherein the processor is further configured to execute instructions stored in the memory:
transmit, to the user devices that have provided at least a promotional communication response or an offer response, a reward for the user's participation.

19. The apparatus of claim 17, wherein the processor is further configured to execute instructions stored in the memory to:
verify each of the plurality of promotional communication responses by receiving at least one of a scanned validation code, an audio message, or a text message from the corresponding user device.

20. The apparatus of claim 19, wherein the processor is further configured to execute instructions stored in the memory to:
make a determination as to whether each promotional communication response occurred prior to a predetermined temporal deadline.
